(19) United States
(12) Patent Application Publication
(10) Pub. No.: US 2010/0214937 A1
(43) Pub. Date: Aug. 26, 2010

(54) Rank Indicator Offset for Periodic CQI Reporting with Periodicity of One

(75) Inventors: Runhua Chen, Dallas, TX (US); Zukang Shen, Richardson, TX (US); Eko N. Onggosanusi, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/685,474

(22) Filed: Jan. 11, 2010

Related U.S. Application Data
(60) Provisional application No. 61/143,926, filed on Jan. 12, 2009.
(60) Provisional application No. 61/143,550, filed on Jan. 9, 2009.

(51) Int. Cl. H04L 12/26

(52) U.S. Cl. 370/252

(57) ABSTRACT

This invention prevents a periodically reported Rank Indicator from interfering with a similarly periodically reported wideband and subband channel quality indicator. Such interference is disadvantageous because it may eliminate wideband channel quality indicator reporting or eliminate each first bandwidth part of subband channel quality indicator reporting. Proper selection of the rank indicator reporting periodicity and offset relative to the wideband and subband channel quality indicator reporting periodicity prevents this interference.

### CLAIM OF PRIORITY

This application claims priority under 35 U.S.C. 119(e)(1) to U.S. Provisional Application No. 61/143,550 filed Jan. 9, 2009 and U.S. Provisional Application No. 61/143,926 filed Jan. 12, 2009.

### TECHNICAL FIELD OF THE INVENTION

The technical field of this invention is mobile wireless telephones.

### BACKGROUND OF THE INVENTION

FIG. 1 shows an exemplary wireless telecommunications network 100. The illustrative telecommunications network includes base stations 101, 102 and 103, though in operation, a telecommunications network necessarily includes many more base stations. Each of base stations 101, 102 and 103 are operable over corresponding coverage areas 104, 105 and 106. Each base station's coverage area is further divided into cells. In the illustrated network, each base station's coverage area is divided into three cells. Handset or other user equipment (UE) 109 is shown in Cell A 108. Cell A 108 is within coverage area 104 of base station 101. Base station 101 transmits to and receives transmissions from UE 109. As UE 109 moves out of Cell A 108 and into Cell B 107, UE 109 may be handed over to base station 102. Because UE 109 is synchronized with base station 101, UE 109 can employ non-synchronized random access to initiate handover to base station 102.

Non-synchronized UE 109 also employs non-synchronous random access to request allocation of up link 111 time or frequency or code resources. If UE 109 has data ready for transmission, which may be traffic data, measurements report, tracking area update, UE 109 can transmit a random access signal on up link 111. The random access signal notifies base station 101 that UE 109 requires up link resources to transmit the UEs data. Base station 101 responds by transmitting to UE 109 via down link 110, a message containing the parameters of the resources allocated for UE 109 up link transmission along with a possible timing error correction. After receiving the resource allocation and a possible timing advance message transmitted on down link 110 by base station 101, UE 109 optionally adjusts its transmit timing and transmits the data on up link 111 employing the allotted resources during the prescribed time interval.

### SUMMARY OF THE INVENTION

This invention prevents a periodically reported Rank Indicator from interfering with a similarly periodically reported wideband and subband channel quality indicator. Such interference is disadvantageous because it may eliminate wideband channel quality indicator reporting or eliminate each first bandwidth part of subband channel quality indicator reporting. Proper selection of the rank indicator reporting periodicity and offset relative to the wideband and subband channel quality indicator reporting periodicity prevents this interference.

### BRIEF DESCRIPTION OF THE DRAWINGS

These and other aspects of this invention are illustrated in the drawings, in which:

FIG. 1 is a diagram of a communication system of the prior art related to this invention having three cells;

FIG. 2 illustrates wideband reporting in subframes, subband reporting in subframes and RI reporting subframes showing overlap in accordance with an example of the prior art; and

FIG. 3 illustrates wideband reporting in subframes, subband reporting in subframes and RI reporting subframes showing overlap in accordance with an example of this invention.

### DETAILED DESCRIPTION OF PREFERRED EMBODIMENTS

To support dynamic scheduling and multiple-input multiple-output (MIMO) transmission in downlink (DL), several control signals must be fed back in uplink (UL). For example, MIMO related feedback information includes: an index of a selected precoding matrix (PMI); transmission rank, which is the number of spatial transmission layers; and supportable modulation and coding schemes (MCS).

In this application PMI and MCS are generally referred to as Channel Quality Indicator (CQI). Note that the feedback frequency and time granularity of MIMO related information can be UE specific. Typically, when there is no data transmission in UL, the control signaling from UE to Evolved Universal Terrestrial Radio Access Node B base station (eNB) is fed back in dedicated UL control channels. Further, the rank feedback time granularity can be larger than the CQI.

Many cellular wireless communication systems such as the Third Generation Partnership Project (3GPP) Evolved Universal Terrestrial Radio Access (E-UTRA) supports periodic CQI reporting. The general reporting principles are: CQI/PMI and Rank Indicator (RI) report and both periodic; wideband CQI/PMI reporting periodicity is an integer multiple to that of the subband CQI reporting; RI reporting periodicity is an integer multiple to that of the wideband CQI report; and the exact reporting instances of wideband CQI, subband CQI and RI have offset values N_{OFFSET,CQI} and N_{OFFSET,RI}.

For 3GPP Long Term Evolution (LTE) E-UTRA (Rel. 8), detailed reporting formats on Physical Uplink Control CHannel (PUCCH) are given in the following. The reporting instances for wideband CQI/PMI are subframes satisfying:

(10×n_{f}+└nₛ/2┘−N_{OFFSET,CQI})mod N_{P}=0 (1)

where: n_{f} is the system frame number: nₛ is the slot index within the frame selected from the set {0, 1, . . . , 19}; N_{OFFSET,CQI} is the corresponding wideband CQI/PMI reporting offset in subframes; and N_{P}, is the wideband CQI/PMI period in subframes. The reporting interval of the RI reporting is an integer multiple M_{RI} of wideband CQI/PMI period N_{P} in subframes. The parameter M_{RI} is selected from the set {1, 2, 4, 8, 16, 32, OFF}.

Where M_{RI} is not OFF, the reporting instances for RI are subframes satisfying:

(10×n_{f}+└nₛ/2┘−N_{OFFSET,CQI}−N_{OFFSET,RI})mod(N_{P}·M_{RI}=0 (2)

where: n_{f} is the system frame number; nₛ is the slot index within the frame selected from the set {0, 1, . . . , 19}; N_{OFFSET,CQI} is the corresponding wideband CQI/PMI reporting offset in subframes; and N_{OFFSET,RI} is the corresponding relative RI offset to the wideband CQI/PMI reporting offset in subframes. The reporting offset for RI N_{OFFSET,RI} takes values from the set {0, −1, . . . , −(N_{P}−1)}.

In case of collision of RI and wideband CQI/PMI the wideband CQI/PMI is dropped.

The periodicity N_{P} and offset N_{OFFSET,CQI} for wideband CQI/PMI reporting are determined based on the parameter cqi-pmi-ConfigurationIndex. The periodicity M_{RI}, and offset N_{OFFSET,RI} for RI reporting are determined based on the parameter ri-ConfigurationIndex. Both cgi-pmi-ConfigurationIndex and ri-ConfigurationIndex are configured by the eNB higher-layer signaling to the UE.

The case where RI and both wideband CQI/PMI and subband CQI reporting are configured is as follows. The reporting instances for wideband CQI/PMI and subband CQI are subframes satisfying:

(1033 n_{f}+└nₛ/2┘−N_{OFFSET,CQI})modN_{P}=0 (3)

where: n_{f} is the system frame number: nₛ is the slot index within the frame selected from the set {0, 1, . . . , 19}; N_{OFFSET,CQI} is the corresponding wideband CQI/PMI reporting offset in subframes; and N_{P} is the period of CQI/PMI reporting instance in subframes.

The wideband CQI/PMI report has period H*N_{P}, and is reported on the subframes satisfying:

(10×n_{f}+└nₛ/2┘−N_{OFFSET,CQI})mod(H·N_{P})=0 (4)

where: n_{f} is the system frame number; and nₛ is the slot index within the frame selected from the set {0, 1, . . . , 19}. The integer H is defined as H=J*K+1, where J is the number of bandwidth parts. Between every two consecutive wideband CQI/PMI reports, the remaining J*K reporting instances are used in sequence for subband CQI reports on K full cycles of bandwidth parts. The reporting interval of RI is M_{RI} times the wideband CQI/PMI period, and RI is reported on the same PUCCH cyclic shift resource as both the wideband CQI/PMI and subband CQI reports. The parameter M_{RI} is selected from the set {1, 2, 4, 8, 16, 32, OFF}.

In case M_{RI} is not OFF, the reporting instances for RI are subframes satisfying:

(10×n_{f}+└s/2┘−N_{OFFSET,CQI}−N_{OFFSET,RI})mod(H·N_{P·M}_{RI})=0 (5)

where: n_{f} is the system frame number; nₛ is the slot index within the frame selected from the set {0, 1, . . . , 19}; N_{OFFSET,CQI} is the corresponding wideband CQI/PMI reporting offset in subframes; and N_{OFFSET,RI} is the corresponding relative RI offset to the wideband CQI/PMI reporting offset in subframes.

In case of collision between RI and wideband CQI/PMI or subband CQI, the wideband CQI/PMI or subband CQI is dropped.

The parameter K is selected from the set {1, 2, 3, 4}, and the parameter N_{OFFSET,RI} is selected from the set {0, −1, . . . , −(N_{P}−1), −N_{P}}.

The periodicity N_{P} and offset N_{OFFSET,CQI} for CQI reporting are determined based on a parameter cqi-pmi-ConfigurationIndex given in separate tables for FDD and for TDD. The periodicity M_{RI}, and offset N_{OFFSET,RI} for RI reporting are determined based on a parameter ri-ConfigurationIndex. Both cgi-pmi-ConfigurationIndex and ri-ConfigurationIndex are configured by higher-layer signaling.

In case of collision between CQI/PMI/RI and acknowledge (ACK)/not acknowledge (NACK) in a subframe, CQI/PMI/RI is dropped if the parameter simultaneousAckNackAndCQI provided by higher layers is set FALSE. Otherwise CQI/PMI/RI is multiplexed with ACK/NACK.

When CQI/PMI reporting has a periodicity Np of 1, CQI/PMI and RI are reported in consecutive subframes suitable for CQI report. This includes all subframes in Frequency Division Duplex (FDD) systems and all uplink and special subframes for Time Division Duplex (TDD) systems. In this case: subband reporting periodicity is Np=1; wideband reporting periodicity is H=J*K+1; and RI reporting periodicity is H*Np*M_{RI}.

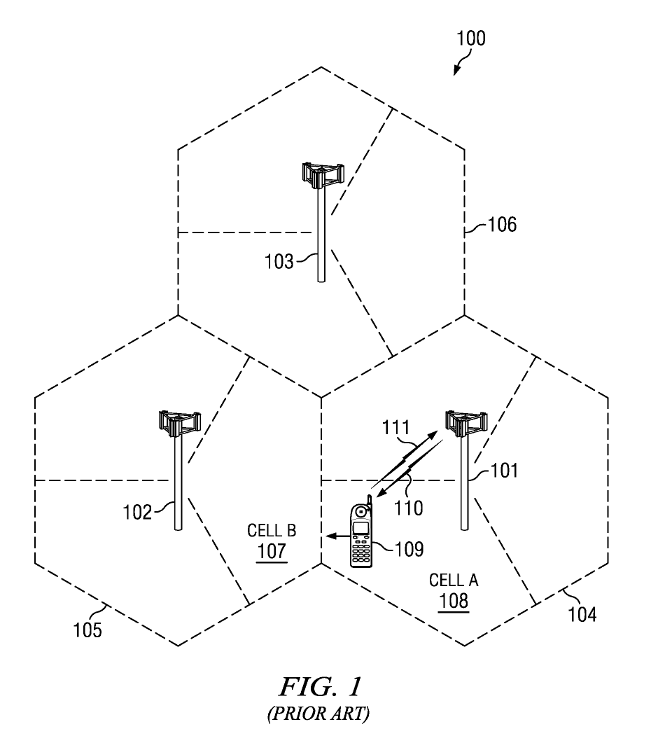

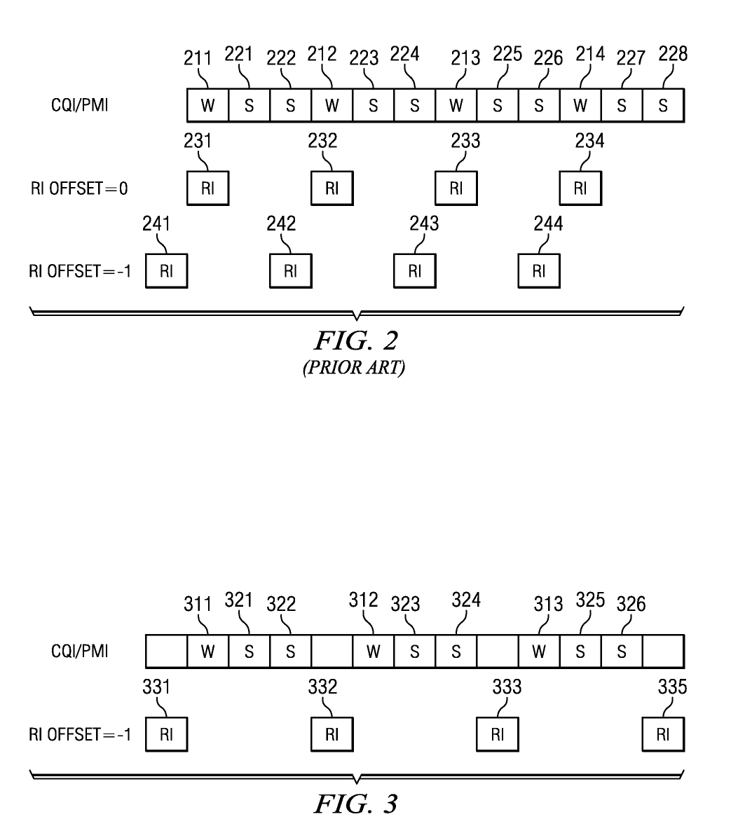

The RI offset can be from the set {0, . . . , −Np} or {0, −1} in this example. This creates some problems when M_{RI}=1. FIG. 1 illustrates one example of this problem. In FIG. 1 Np=1, J=2, K=1, M_{RI}=1. If N_{OFFSET,RI}=0 all wideband CQI (WB) is punctured. FIG. 2 illustrates wideband reporting in subframes 211, 212, 213 and 214. FIG. 2 illustrates subband reporting in subframes 221, 222, 223, 224, 225, 226, 227 and 228. FIG. 2 illustrates if N_{OFFSET,RI}=0 then RI reporting subframes 231, 232, 233 and 234 overlap wideband reporting subframes 211, 212, 213 and 214. The RI reporting subframes overlap and preempt the wideband reporting subframes.

This is problematic because the eNB will not receive any wideband CQI/PMI report in this reporting configuration. This significantly reduces the CQI reporting reliability and downlink data throughput because wideband CQI/PMI provides a reference for the entire system bandwidth. Since the subband CQI is conditioned on the wideband CQI report, the eNB will not be able to correctly interpret the subsequent subband CQI report since no wideband CQI is received.

FIG. 2 further illustrates the RI reporting subframes 241, 242, 243 and 244 for a RI offset of −1. If N_{OFFSET,RI}=−1, all subband CQI reporting for the first bandwidth part is punctured, that is preempted by the RI reporting subframes. This means that the eNB will have no subband CQI information for the first bandwidth part and must use the less accurate wideband CQI. This also negatively impacts the downlink scheduling and data transmission performance and results in unbalanced spectrum utilization.

These problems arise due to the configuration of wideband CQI reporting periodicity of H=J*K+1. This leaves no uplink reporting instances for RI report. The following invention solves this problem.

In the invention for CQI/PMI reporting periodicity Np=1, when M_{RI}>1 the wideband CQI reporting periodicity is configured H*Np where H=J*K+1. Rank reporting offset N_{OFFSET,RI} is selected from the set {0, −1, , −(Nₚ−1), −N_{P}}. Rank reporting periodicity is M_{RI}*H*Np and the rank reporting offset N_{OFFSET,RI} is selected from the set {0, −1, . . . , −(N_{P}−1), −N_{P}}. When N_{RI}=1, the wideband CQI reporting periodicity is configured as H*Np where H=J*K+n and n is a positive integer number greater than 1. Rank reporting periodicity is M_{RI}*H*Np and the rank reporting offset N_{OFFSET,RI} is selected from the set {0, −1, . . . , −(N_{P}−1), −N_{P}}. In other words, (n-1) additional CQI reporting instances are appended between two consecutive wideband CQI reports which could be appropriately used for rank reports. Alternatively, the rank reporting offset N_{OFFSET,RI} is selected from the set {0, −1, . . . , −(H-1)}.

FIG. 3 illustrates one example of N_{RI}=1 where Np=1, J=2, K=1, N_{OFFSET,RI}=−1. FIG. 3 illustrates wideband reporting in subframes 311, 312 and 313. FIG. 3 illustrates subband reporting in subframes 321, 322, 323, 324, 325 and 326. FIG. 3 illustrates RI reporting subframes 331, 332, 333 and 334. FIG. 3 shows that no wideband or subband CQI/PMI needs to be dropped. Thus the eNB receives complete rank, wideband and subband CQI information. As a consequence the CQI reporting reliability and downlink data transmission is much improved.

Alternatively, it is possible to exclude the configuration of M_{RI}=1 when CQI periodicity Np=1.

When the CQI reporting periodicity Np=1, the multiplicity of the rank reporting periodicity to the wideband CQI reporting periodicity M_{RI} must be greater than 1, i.e., M_{RI}>1. The configuration of N_{P}=1 and M_{RI}=1 is not allowed in CQI reporting.

What is claimed is:

1. A method of CQI/PMI/RI reporting having a periodicity in subframes of Np=1, comprising the step of:
when M_{RI}>1
setting a wideband CQI reporting periodicity of an integer H times the periodicity in subframes Np where H=J*K+1, J being a number of bandwidth parts and K selected from the set of {1, 2, 3, 4}, and
selecting a reporting offset N_{OFFSET,RI} from the set {0, −1, , −(Ar_{P}−1), −N_{P}} thereby setting a rank reporting periodicity of M_{RI}*H*Np; and
when M_{RI}=1
setting a wideband CQI reporting periodicity of an integer H times the periodicity in subframes Np where H=J*K+n and n is a positive integer number greater than 1, and
selecting a rank reporting offset N_{OFFSET,RI} from the set {0, −1, . . . , −(N_{P}−1), −N_{P}} thereby setting a rank reporting periodicity of M_{RI}*H*Np.

2. The method of claim 1, wherein:
said step of the rank reporting offset N_{OFFSET,RI} from the set {0, −1, . . . , −(N_{P}−1), −N_{P}} includes appending (n−1) additional CQI reporting instances between two consecutive wideband CQI reports which could be appropriately used for rank reports.

3. The method of claim 1, wherein:
said step of setting a wideband CQI reporting periodicity includes indexing a first look up table;
said step of selecting a reporting offset N_{OFFSET,RI} includes indexing a second look up table.

4. The method of claim 3, further comprising:
a base station configuring said first and second look up tables in a user equipment by higher-layer signaling.

5. A method of CQI/PMI/RI reporting having a periodicity in subframes of Np=1, comprising the step of:
requiring the multiplicity of the rank reporting periodicity to a wideband CQI reporting periodicity M_{RI} to be greater than 1.

6. A method of CQI/PMI/RI reporting having a periodicity in subframes of Np=1, further comprising the step of:
prohibiting CQI reporting having N_{P}=1 and M_{RI}=1.
